(19) United States
(12) Patent Application Publication
(10) Pub. No.: US 2025/0187668 A1
(43) Pub. Date: Jun. 12, 2025

(54) Vehicle floor panel reinforcement member

(71) Applicant: ArcelorMittal, Luxembourg (LU)

(72) Inventors: Joel WILSIUS, Paris (FR); Gilson DONYA, Nanterre (FR)

(21) Appl. No.: 18/844,140

(22) PCT Filed: Mar. 1, 2023
(86) PCT No.: PCT/IB2023/051901

§ 371 Date: Sep. 5, 2024

(30) Foreign Application Priority Data
Mar. 11, 2022 (WO) PCT/IB2022/052208

(51) Int. Cl. B62D 21/15; B23K 26/21

(52) U.S. Cl. CPC B62D 21/152; B23K 26/21

(57) ABSTRACT

Floor panel reinforcement member (1) for an automotive vehicle (100) attached to a floor panel (3) and including at least a front longitudinal portion (11) extending substantially longitudinally from a dash panel (4) to a transition portion (31) and forming with the floor panel (3) a front longitudinal hollow volume (10), a front transverse portion (21) extending in a substantially transverse direction between right and left side sills (61, 62) of the vehicle, forming with the floor panel (3) a front transverse hollow volume (20) and connected to the front longitudinal portion (11) in the transition portion (31), wherein the floor panel reinforcement member (1) is manufactured by forming a single metal blank (7).

The present invention relates to structural parts for an automotive vehicle and in particular to the reinforcement structure of the vehicle's floor panel.

### BACKGROUND

Car makers are submitted to the ever more demanding requirements of increasing the passive safety of vehicles, lowering the weight of the vehicle to minimize greenhouse gas emissions in case of internal combustion engines or increasing the vehicle's driving range in case of electric vehicles, while keeping production costs low and productivity rates high.

### SUMMARY OF THE INVENTION

The floor panel reinforcement member forms a key structural component of a motor vehicle and contributes to the safety of the occupants in case of a front or lateral crash. It also plays an important role in protecting the battery pack or High Voltage Battery and its housing (HV Battery housing) in the case of electric or hybrid vehicles or the hydrogen tank in the case of a fuel cell. Indeed, these elements are generally located below the floor panel. When the vehicle suffers a front crash, the longitudinal elements of the floor panel reinforcement member pick up the impact energy transmitted by the front crash management system and act to further absorb part of the crash energy as well as preventing intrusion into the passenger compartment. In a similar way, the transversal elements of the floor panel reinforcement member pick up the impact energy transmitted by the side sills and act to absorb energy and prevent intrusion. Furthermore, the floor panel reinforcement member plays an important role in ensuring the overall rigidity of the vehicle body.

The floor panel reinforcement member is involved in improving the safety performance of the vehicle in various regulatory tests, such as for example:
the Insurance Institute for Highway Safety's (IIHS) Small Overlap Rigid Barrier (SORB) crash, in which a vehicle is impacted with only 25% overlap in the width by a rigid barrier moving at 64.4 km/h.
the IIHS's front overlap deformable barrier (ODB), in which a vehicle is impacted with only 25% overlap in the width by a rigid barrier moving at 64.4 km/h.
the US New Car Assessment Program's (USNCAP) pole tests, in which a vehicle having an initial lateral speed of 32.2 km/h impacts on its side a fixed pole.
the IIHS's side moveable deformable barrier (MDB) test, in which a vehicle is impacted on its side by a deformable barrier having a weight of 1500 kg and travelling at a speed of 50 km/h.

It is an object of the present invention to provide a floor panel reinforcement member having a very high crash management efficiency. It is also an object of the present invention to provide a vehicle with a floor panel reinforcement member according to the invention.

It is also an alternate or additional object of the current invention to provide a floor panel reinforcement member having a lower weight than current designs, thereby saving fuel in the case of combustion engines and increasing driving range in the case of electric engines driven vehicles.

Furthermore, it is an alternate or additional object of the present invention to address the challenges of increasing productivity, diminishing complexity and diminishing costs in vehicle production. Indeed, the current invention provides a floor panel reinforcement member having fewer parts than the reference designs. The inventive design can be produced and assembled in very few manufacturing steps compared to the reference. On top of simplifying production, diminishing the number of production steps also diminishes the environmental footprint of the production process and diminishes overall CO2 emissions when manufacturing the vehicle.

The present invention provides a floor panel reinforcement member (1) for an automotive vehicle (100) attached to a floor panel (3) and comprising at least a front longitudinal portion (11), a front transverse portion (21) and a front transition portion (31), such that:
said front longitudinal portion (11), front transverse portion (21) and front transition portion (31) each comprise at least a left and right side wall extending from the floor panel (3) at least in an elevation direction up to a higher elevation than the floor panel (3),
said front longitudinal portion (11) extending substantially longitudinally from a dash panel (4) to said front transition portion (31) and forming with said floor panel (3) a front longitudinal hollow volume (10),
said front transverse portion (21) extending in a substantially transverse direction between right and left side sills (61, 62) of said vehicle, forming with said floor panel (3) a front transverse hollow volume (20) and connected to said front longitudinal portion (11) in the front transition portion (31),
wherein said floor panel reinforcement member (1) is manufactured by forming a single metal blank (7).

The present invention also provides an automotive vehicle (100) comprising a floor panel reinforcement member (1) as described above.

In the following descriptions and claims, the directional terms are defined according to the usual directions of a mounted vehicle.

In particular, the terms “top”, “up”, “upper”, “above”, “bottom”, “low”, “lower”, “below” etc. are defined according to the elevation direction of a vehicle. The terms “front”, “back”, “rear”, “front”, “forward”, backward” etc. are defined according to the longitudinal direction of a vehicle, i.e. the direction in which the vehicle moves when following a straight line. The terms “left”, “right”, “transverse”, etc. are defined according to the orientation parallel to the width of the vehicle. The terms “inner”, “outer” are to be understood according to the width direction of the vehicle: the “inner” is closest to the central axis of the vehicle, i.e. closest to the inside of the vehicle, whereas the “outer” is located further away from said central axis of the vehicle, in effect closer to the outside of the vehicle. The same applies to the terms “distal” and “central”: the “distal” part is located closest to the outside of the vehicle and the “central” part closest to the center of the vehicle. The term “horizontal” refers to the orientation of the plane comprising the longitudinal and the transverse directions. The term “vertical” refers to any orientation comprising the elevation direction.

In the following figures, the orientations and spatial references are all made using an X, Y, Z coordinates referential, wherein Z is the elevation direction of the vehicle, X is the longitudinal direction of the vehicle and Y is the transverse direction of the vehicle. The referential is represented in each figure. When the figure is a 2D flat representation, the axis which is outside of the figure is represented by a dot in a circle when it is pointing towards the reader and by a cross in a circle when it is pointing away from the reader, following established conventions.

By “substantially parallel” or “substantially perpendicular” it is meant a direction
which can deviate from the parallel or perpendicular direction by no more than 15°.

A steel sheet refers to a flat sheet of steel. It has a top and bottom face, which are also referred to as a top and bottom side or as a top and bottom surface. The distance between said faces is designated as the thickness of the sheet. The thickness can be measured for example using a micrometer, the spindle and anvil of which are placed on the top and bottom faces. In a similar way, the thickness can also be measured on a formed part.

By average thickness of a part, or of a portion of a part, it is meant the overall average thickness of the material making up the part after it has been formed into a 3-dimensional part from an initially flat sheet.

Tailor welded blanks are made by assembling together, for example by laser welding together, several sheets or cut-out blanks of steel, known as sub-blanks, in order to optimize the performance of the part in its different areas, to reduce overall part weight and to reduce overall part cost. The sub-blanks forming the tailor welded blanks can be assembled with or without overlap, for example they can be laser butt-welded (no overlap), or they can be spot-welded to one another (with overlap).

By opposition to a tailor welded blank, a monolithic blank refers to a blank which consists of one single sub-blank, without several sub-blanks being combined together.

A tailor rolled blank is a blank having multiple sheet thicknesses obtained by differential rolling during the steel sheet production process.

The ultimate tensile strength, the yield strength and the elongation are measured according to ISO standard ISO 6892-1, published in October 2009. The tensile test specimens are cut-out from flat areas. If necessary, small size tensile test samples are taken to accommodate for the total available flat area on the part.

The bending angle is measured according to the VDA-238 bending standard. For the same material, the bending angle depends on the thickness. For the sake of simplicity, the bending angle values of the current invention refer to a thickness of 1.5 mm. If the thickness is different than 1.5 mm, the bending angle value needs to be normalized to 1.5 mm by the following calculation where α1.5 is the bending angle normalized at 1.5 mm, t is the thickness, and at is the bending angle for thickness t:

$$α1.5 = ( α t \times √ t ) / √ 1.5$$

Hot stamping is a forming technology for steel which involves heating a blank of steel, or a preformed part made from a blank of steel, up to a temperature at which the microstructure of the steel has at least partially transformed to austenite, forming the blank or preformed part at high temperature by stamping it and simultaneously quenching the formed part to obtain a microstructure having a very high strength, possibly with an additional partitioning or tempering step in the heat treatment.

A multistep hot stamping process is a particular type of hot stamping process including at least one stamping step and consisting of at least two process steps performed at high temperature, above 300° C. For example, a multistep process can involve a first stamping operation and a subsequent hot trimming operation, so that the finished part, at the exit of the hot stamping process, does not need to be further trimmed. For example, a multistep process can involve several successive stamping steps in order to manufacture parts having more complex shapes then what can be realized using a single stamping operation. For example, the parts are automatically transferred from one operation to another in a multistep process, for example using a transfer press. For example, the parts stay in the same tool, which is a multipurpose tool that can perform the different operations, such as a first stamping and a subsequent in-tool trimming operation.

The term “bottling” refers to the mode of deformation of a part subjected to a compressive load, typically a high slenderness part, where the part progressively absorbs the mechanical energy of the compressive load by forming a series of successive waves resulting from successive local buckling deformations of the part. As a result, the length of the part as measured in the direction of the compressive load is smaller after the deformation than the initial length of the part in said direction. In other words, when a part reacts to a compressive load by controlled buckling, it folds onto itself in the same way as a plastic bottle on which a compressive load is applied between the top and the bottom of the bottle.

### BRIEF DESCRIPTION OF THE DRAWINGS

FIG. 1 is a perspective view of an automotive vehicle having a floor panel reinforcement member according to the present invention,

FIG. 2 is a perspective view of a first embodiment of a floor panel reinforcement member according to the present invention,

FIG. 3 is a perspective view of a second embodiment of a floor panel reinforcement member according to the present invention,

FIG. 4 is a perspective view of a third embodiment of a floor panel reinforcement member according to the present invention,

FIG. 5 is a perspective view of a fourth embodiment of a floor panel reinforcement member according to the present invention,

FIG. 6 is a perspective view of a fifth embodiment of a floor panel reinforcement member according to the present invention.

FIG. 7 is a perspective view of a metal blank used to manufacture a floor panel reinforcement member according to the present invention.

FIG. 8A is a top view of a floor panel reinforcement member according to the first embodiment represented on FIG. 1 and FIG. 8B is the transverse cross section according to axis A-A defined on FIG. 8A. It should be noted that compared to the original computer assisted design of the floor panel reinforcement member used for the first embodiment, the cross section of FIG. 8B has been exaggeratedly elongated in the elevation direction in order to better represent the height of the side wall H₂₀.

### DETAILED DESCRIPTION

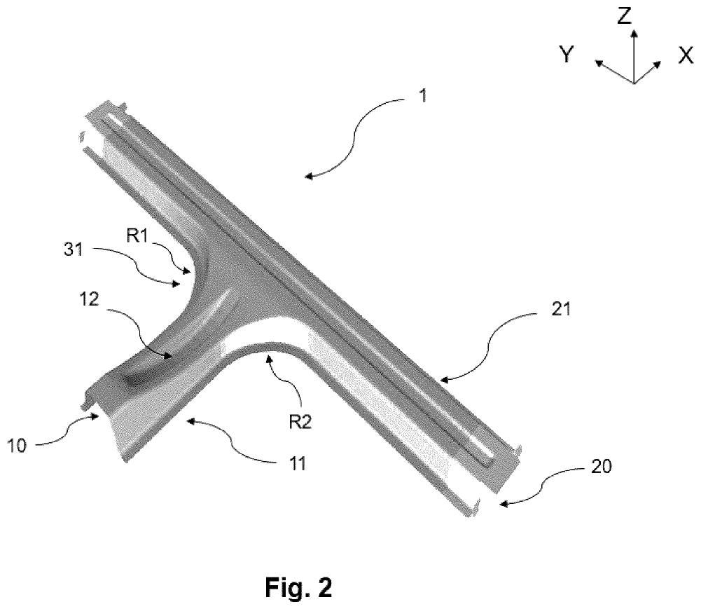

In FIGS. 2-6 the floor panel reinforcement members are represented individually without showing the surrounding vehicle parts for clarity's sake. In the following description however, the floor panel reinforcement members of the figures are described in their assembled state within a vehicle structure.

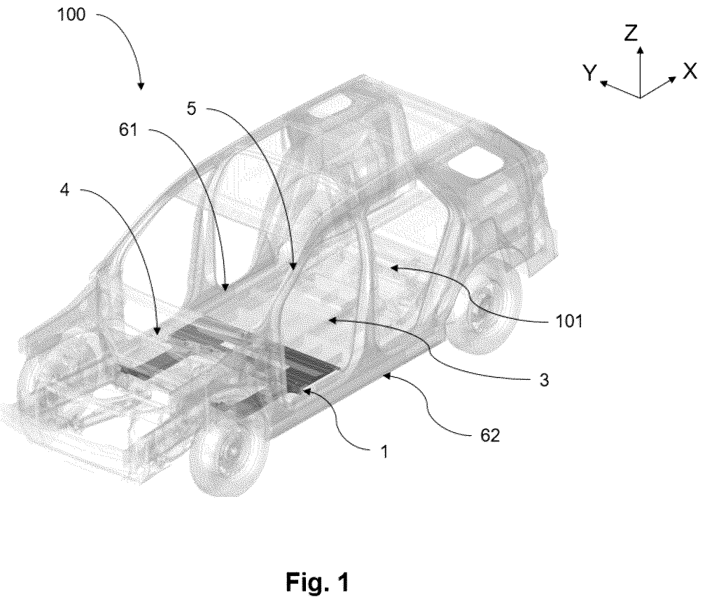

Referring to FIG. 1, a passenger compartment 101 of an automotive vehicle 100 is the volume accessible to the occupants of the vehicle. For obvious safety reasons, said passenger compartment 101 needs to be protected in the case of a crash. The lower part of the passenger compartment is delimited by a floor panel 3, which extends longitudinally from a dash panel 4 at the front to a heelboard 5 at the back. The floor panel 3 further extends transversally in between right and left side sills 61, 62. In the case of an electric vehicle, the HV battery housing is generally located below the floor panel 3.

A floor panel reinforcement member 1 according to the invention is located on top of said floor panel 3 and has side walls which extend at least in the elevation direction from a base elevation corresponding to the elevation of the floor panel 3 to a higher elevation above the floor panel 3. When saying that the side walls extend at least in an elevation direction, it is meant that the direction in which the side walls extend comprises at least an elevation component but can also comprise a longitudinal and/or transversal component. In other words, the side walls extend in an elevation direction, possibly with an angle towards the elevation direction.

The floor panel reinforcement member 1 extends in the longitudinal direction from the dash panel 4 towards the rear of the vehicle. In the transverse direction the floor panel reinforcement member 1 extends between the right and left side sills 61, 62. As will be subsequently described, according to the specific embodiment, the floor panel reinforcement member 1 can extend longitudinally towards the rear of the vehicle up to the heelboard 5, it can also extend longitudinally only up to a point located forward of the heelboard 5. On the other hand, the floor reinforcement structure 1 according to the invention necessarily extends transversally between the right and left side sills 61, 62.

Referring to FIG. 2, the floor panel reinforcement member 1 according to the invention comprises at least a front longitudinal portion 11 a front transverse portion 21 and a front transition portion 31. When assembled within the vehicle, said front transverse portion 11 extends substantially longitudinally from the dash panel 4 to the front transition portion 31. When assembled to the vehicle, said front transverse portion 21 extends substantially transversally between the right and left side sills 61, 62. The front transition portion 31 ensures the transition in orientation between the front longitudinal portion 11, which extends substantially longitudinally, and the front transverse portion 21, which extends substantially transversally. To that end, the side walls of the front transition portion 31 are curved.

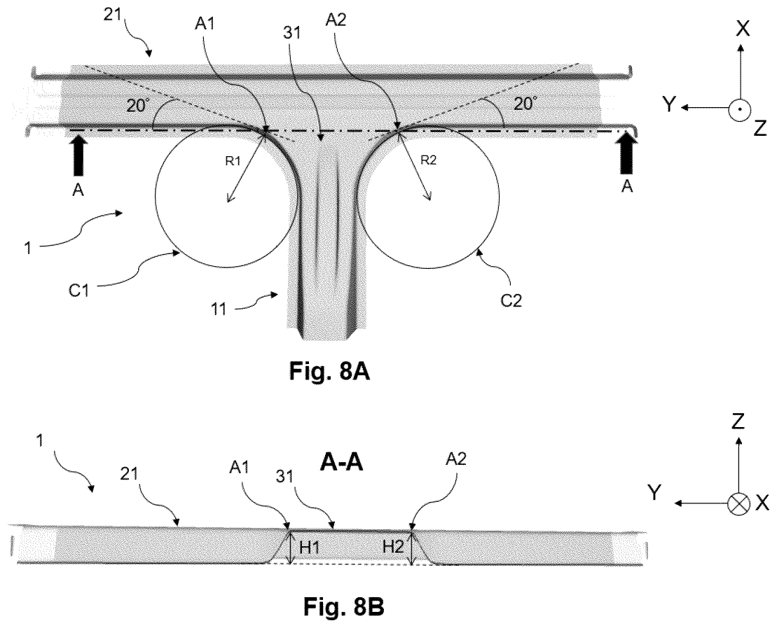

Referring to FIGS. 2 and 8A, the curvature of said side walls of the transition portion 31 is measured by a curvature radius R1, R2 respectively for the right and left side wall. Said curvature radius R1, R2 is defined as the radius of the circle whose arc comes closest to the curved shape of the side walls in the transition portion 31. Said circles have been represented in FIG. 8A with the references C1 and C2 respectively corresponding to the right and left hand side curvature radius R1, R2.

When assembled within the vehicle, the floor panel reinforcement member 1 is at least attached to the floor panel 3, for example by spot welding on flanges or laser welding on flanges, such as for example remote laser welding or remote laser stitch welding. In a specific embodiment, the floor panel reinforcement member 1 is further attached to the dash panel 4. Thanks to the fact that the side walls extend at least in the elevation direction, the assembled floor panel reinforcement member 1 forms with the floor panel 3 a front longitudinal hollow volume 10 in the longitudinal direction and a front transverse hollow volume 20 in the transverse direction. Said front longitudinal hollow volume 10 extends in a substantially longitudinal direction from the dash panel 4 to the front transition portion 31. Said transverse hollow volume 20 extends in a substantially transverse direction between the right and left side sills 61, 62. The front longitudinal and transverse hollow volumes 10, 20 are connected in the front transition portion 31.

Said front longitudinal and transverse hollow volumes 10, 20 are important in resisting crash energy, absorbing crash energy and increasing overall vehicle stiffness. Indeed, it is thanks to the presence of hollow volumes that the overall inertia and therefore structural resistance of the vehicle can be guaranteed.

The floor panel reinforcement member according to the invention is manufactured by forming a single metal blank into the desired shape of the final part. Forming is for example done by stamping said metal blank. For example, the stamping operation is a hot stamping operation or a multi-step hot stamping operation.

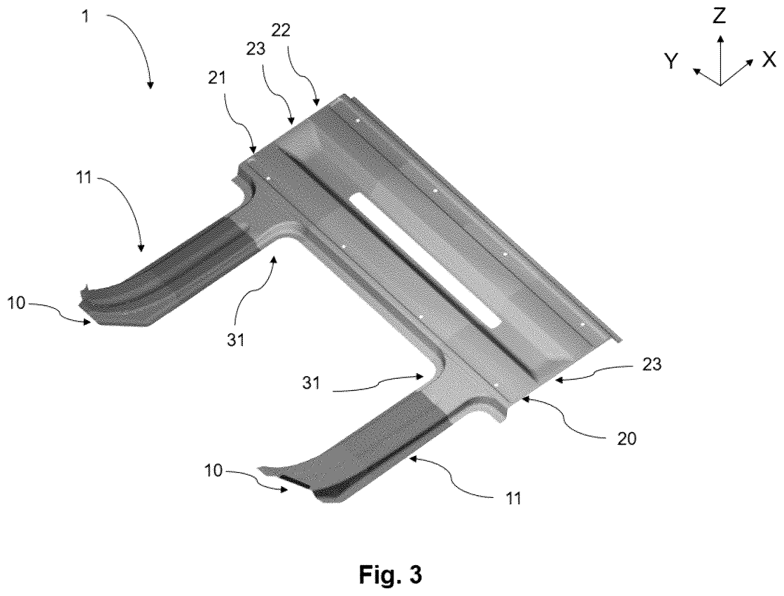

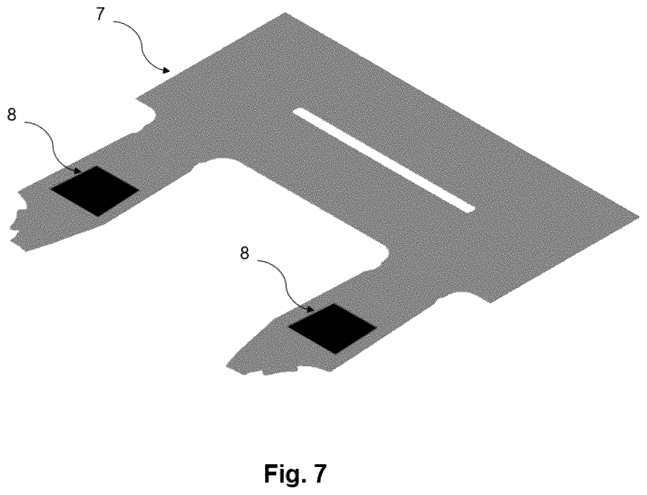

An example of such a single metal blank 7 is represented on FIG. 7. It corresponds to the blank which is used to manufacture the floor panel reinforcement member 1 of FIG. 3.

For example, the single metal blank is a laser welded blank made up of several sub blanks joined together by laser butt welding or joined together by spot welding or a combination of both. For example, the single metal blank is a tailor rolled blank.

Thanks to the fact that the floor panel reinforcement member is made from one single metal sheet, the manufacturing process is greatly simplified compared to traditional designs in which several parts are made from several different blanks and are subsequently assembled together. This simplification leads to productivity gains and to cost reductions when manufacturing the vehicle. Thanks to the reduced complexity in logistics and manufacturing, this simplification can also contribute to decrease CO2 emissions during vehicle manufacturing.

A further advantage of the integration of longitudinal and transverse elements in one single part made from one single blank is the absence of assembly points, which can lead to structural weaknesses. Indeed, because the part is one single standing element, it does not comprise assembly points between different subparts, which are potential structural weaknesses. For example, if the individual parts of a traditional multi-part design are welded together, the heat affected zones generated by the welding operation or the weld nuggets themselves can be structural weaknesses in the assembly, which will lead to failure in the case of crash or due to fatigue stresses or other solicitations. Furthermore, the absence of assembly points also allows for an optimal structural cooperation between the different elements of the reinforcement structure. For example, when the part is submitted to a longitudinal stress in the case of a front crash, the front longitudinal portion 11 will be heavily involved in resisting and absorbing the crash energy, but it will also be able to rely on the front transverse portion 21 to resist and absorb part of the crash energy and also to divert said crash energy transversally in order to involve as much of the vehicle structure as possible in resisting an absorbing the crash energy.

Furthermore, the absence of assembly points between several individual parts is a source of overall weight saving. Indeed, assembling several parts together requires overlap areas, in which two thicknesses of metal overlap each other, leading to increased weight compared to an integrated design.

In a specific embodiment, such as depicted on FIG. 2, the front longitudinal portion 11 comprises a front longitudinal rib 12, located on the top of said longitudinal portion. Said rib 12 improves the rigidity and thus the crash resistance and stiffness performance of said front longitudinal portion 11.

In a specific embodiment, such as depicted on FIG. 2, the front transverse portion 21 comprises a front longitudinal rib 22, located on the top of said longitudinal portion. Said rib 22 improves the rigidity and thus the crash resistance and stiffness performance of said front longitudinal portion 21.

In a specific embodiment, a specific ratio limit is set between the side wall curvature radii in the transition portion 31 and the height of the side wall of the transition portion 31. More precisely, referring to FIGS. 8A and 8B, H1 and H2 are the heights respectively of the right and left side walls of the transition portion 31 at the point where the side wall forms an angle with the transverse direction of 20°. On FIGS. 8A and 8B, the points at which the right and left side walls form an angle with the transverse direction of 20° are designated respectively by A1 and A2.

When several separate front longitudinal portions 11 are present in the design of the floor panel reinforcement member and thus when several front transition portions 31 are present, such as depicted in FIG. 3, it is necessary to take into account the contribution of each of these transition portions 31 in the above-mentioned ratio.

The number n of front longitudinal portions 11 is an integer equal to or higher than 1 counting the number of separate front longitudinal portions 11 in the floor panel reinforcement member. For example, in FIG. 2 n=1, while in FIG. 3 n=2.

In a specific embodiment, the product of the number n of separate front longitudinal portions 11 by the ratio of the sum of the transition portion side wall curvature radii R1, R2 to the sum of the heights of the transition portion side walls H1, H2 is at least equal to 4. This can be expressed by the following formula:

$$n * \frac{{\sum }_{for each transition portion} ( R 1 + R 2 )}{{\sum }_{for each transition portion} ( H 1 + H 2 )} \geq 4$$

The inventors have found that the crash performance, in particular the side impact crash resistance, was improved by ensuring a minimum ratio between the side wall curvatures in the transition portions and the height of the side wall of the transition portion close to the transverse portion. Indeed, when confronted with a side impact, the side walls of the front transverse portion act to absorb and resist to the compressive crash load. The curving of the side walls in the transition portions 31 potentially represents a weakness towards said compressive load in which stress concentration can lead to collapse. The inventors have found that by guaranteeing the above described ratio, it was possible to ensure very good transverse dynamic loading properties to the floor panel reinforcement member.

For example, the inventors have found that very good side impact behaviors were obtained by using the following floor panel reinforcement members:

| | | Example 1 | Example 2 |
|---|---|---|---|
| | | (see fig 2) | (see fig 3) |
| First | R1 (mm) | 144 | 76 |
| transition | R2 (mm) | 144 | 64 |
| portion | H1 (mm) | 32 | 34 |
| | H2 (mm) | 32 | 34 |
| Second | R1 (mm) | — | 76 |
| transition | R2 (mm) | | 64 |
| portion | H1 (mm) | | 34 |
| | H2 (mm) | | 34 |

| | | |
|---|---|---|
| n | 1 | 2 |
| $n * \frac{{\sum }_{i = 1}^{n} ( R 1 + R 2 )}{{\sum }_{i = 1}^{n} ( H 1 + H 2 )}$ | 4.5 | 4.1 |

In a specific embodiment, the front longitudinal portion 11 further comprises a deformable portion extending over a front part of said front longitudinal portion 11 and a non-deformable portion extending over a rear part of said portion 11. The resistance to plastic deformation of said deformable portion is lower than the resistance to plastic deformation of said non-deformable portion. For example, the product of the tensile strength by the average thickness of said deformable portion is lower than the product of the tensile strength by the average thickness of said non-deformable portion. Advantageously, in the case of a front impact, this allows to manufacture a floor panel reinforcement member 1 having a front part corresponding to the deformable portion, which will undergo plastic deformation, for example by bottling, thus absorbing part of the crash energy. At the same time, the non-deformable portion, located at the rear, thus closest to the occupants of the vehicle, will resist intrusion, thus protecting the passengers and the HV Battery housing, while transmitting the remaining energy of the impact to the rest of the vehicle structure.

In a specific embodiment, the front transverse portion 21 further comprises a deformable portion extending over a distal part of said front transverse portion and a non-deformable portion extending over a central part of said portion. In a specific embodiment, the deformable portions are located on both sides of the front transverse portion. The resistance to plastic deformation of said deformable portion is lower than the resistance to plastic deformation of said non-deformable portion. For example, the product of the tensile strength by the average thickness of said deformable portion is lower than the product of the tensile strength by the average thickness of said non-deformable portion. Advantageously, in the case of a side impact, this allows to manufacture a floor panel reinforcement member 1 having a distal part corresponding to the deformable portion, which will undergo plastic deformation, for example by bottling, thus absorbing part of the crash energy. At the same time, the non-deformable portion, located towards the center, thus closest to the occupants of the vehicle, will resist intrusion, thus protecting the passengers and the HV battery housing, while transmitting the remaining energy of the impact to the rest of the vehicle structure.

In a specific embodiment, the above described deformable and non-deformable portions are obtained by manufacturing the floor panel reinforcement member using a laser welded blank comprising material having a lower resistance to plastic deformation after forming in the deformable portions than in the non-deformable portions.

In a specific embodiment, represented in FIG. 2, the floor panel reinforcement member 1 consists only of a front longitudinal portion 11 and a front transverse portion 21. For example, the front longitudinal portion is located centrally, for example aligned with the center of the dash panel 4. For example, the front longitudinal portion takes the place of what is commonly known as the tunnel reinforcement. For example, the front transverse portion takes the place of the front seat floor cross member.

In a specific embodiment, represented in FIG. 3, the floor panel reinforcement member 1 consists only of two front longitudinal portions 11 and a front transverse portion 21. For example, the front longitudinal portions are located towards the side of the floor panel reinforcement, for example aligned with the front longitudinal members located in the front end of the vehicle (not represented in the figures).

In a specific embodiment, represented in FIG. 3, the floor panel reinforcement member 1 comprises two front longitudinal portions 11 and a front transverse portion 21. For example, the front longitudinal portions are located towards the side of the floor panel reinforcement, for example aligned with the front longitudinal members located in the front end of the vehicle (not represented in the figures).

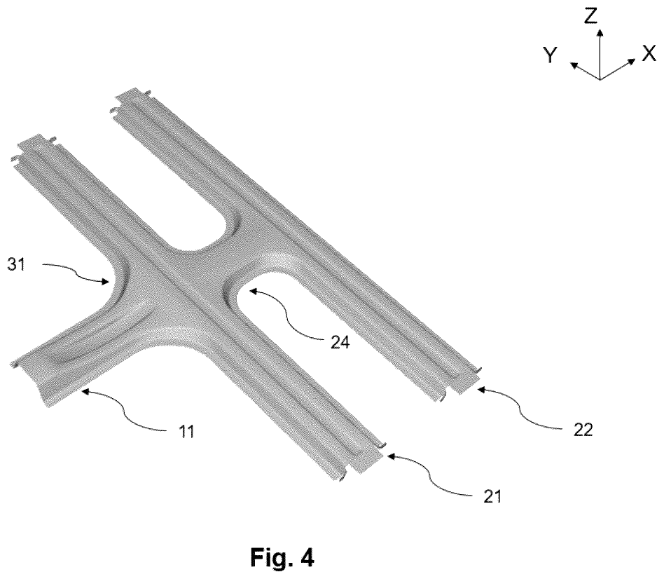

In a specific embodiment, represented in FIGS. 3 and 4, the floor panel reinforcement member 1 comprises a front transverse portion 21 and at least a further transverse portion 22 extending in a substantially transverse direction between the side sills 61, 62 and having side walls extending at least in an elevation direction such that said further transverse portion 22 forms a further transverse hollow volume with the floor panel 3. Advantageously, this allows to further integrate transverse cross members within the floor panel reinforcement member, leveraging further on the production simplification and structural optimization advantages explained above.

In a specific embodiment, the floor panel reinforcement member 1 comprises a further transverse portion 22 having a deformable portion extending over a distal part of said further transverse portion and a non-deformable portion extending over a central part of said portion. In a specific embodiment, the deformable portions are located on both sides of the further transverse portion. The resistance to plastic deformation of said deformable portion is lower than the resistance to plastic deformation of said non-deformable portion. For example, the product of the tensile strength by the average thickness of said deformable portion is lower than the product of the tensile strength by the average thickness of said non-deformable portion. Advantageously, in the case of a side impact, this allows to manufacture a floor panel reinforcement member 1 having a distal part corresponding to the deformable portion, which will undergo plastic deformation, for example by bottling, thus absorbing part of the crash energy. At the same time, the non-deformable portion, located towards the center, thus closest to the occupants of the vehicle, will resist intrusion, thus protecting the passengers and the HV battery housing, while transmitting the remaining energy of the impact to the rest of the vehicle structure. When combining this embodiment with the above described embodiment in which the front transverse portion 21 also comprises a distal part having a deformable portion, the deformable portions of the front transverse portion 21 and the one or several further transverse portions 22 can cooperate to absorb energy together in the case of a lateral impact and the non-deformable portions cooperate to resist intrusion.

In a specific embodiment, represented in FIG. 3, the further transverse portion 22 is attached to the floor panel reinforcement member by lateral intermediate portions 23, which extend substantially in a longitudinal direction between the sides of the transverse portions. This design allows for easy integration of the floor panel reinforcement member into the vehicle assembly and provides very good overall structural soundness to the floor panel reinforcement member 1. The presence of two lateral intermediate portions 23 further increases the strength of the floor panel assembly and its overall contribution to the stiffness of the vehicle body.

In a specific embodiment, represented in FIG. 4, the further transverse portion 22 is attached to the floor panel reinforcement member by a central intermediate portion 24. For example, said central intermediate portion 34 comprises side walls extending at least in an elevation direction and forming a further longitudinal hollow volume with the floor panel 3. Advantageously, this allows to prolong the load path of the front longitudinal portion, thereby increasing the resistance to front impacts. It also increases the overall stiffness performance of the vehicle.

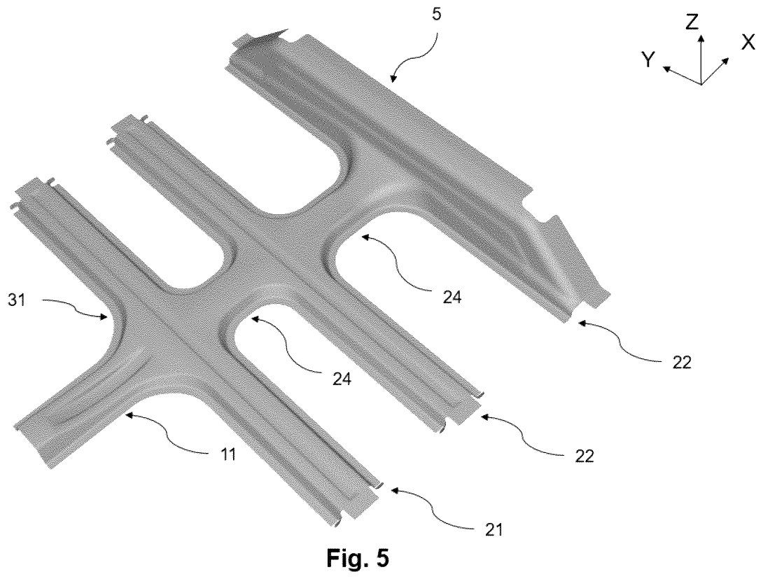

In a specific embodiment, represented in FIG. 5, the floor panel reinforcement member comprises two further transverse portions 22 each attached to the floor panel reinforcement member 1 by central intermediate portions 24. In the embodiment represented in FIG. 5, the floor panel reinforcement member 1 further comprises the heelboard 5. This design allows for a very large floor panel reinforcement member, thus yielding further advantages of the above described benefits of parts integration.

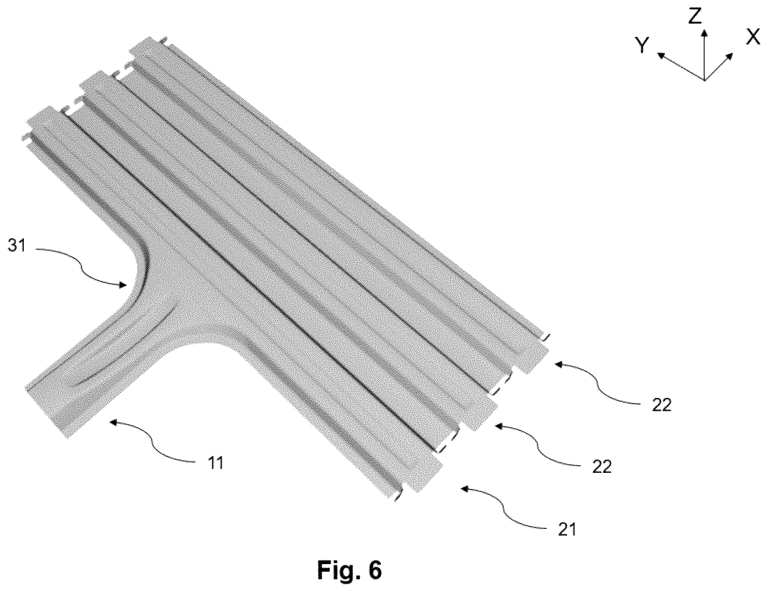

In a specific embodiment, represented in FIG. 6, the floor panel reinforcement member comprises two further transverse portions 22 attached directly one to another and to the front transverse portion 21. This allows for a very sturdy, compact, resistant and stiff design.

In a specific embodiment, represented on FIG. 7, the metal blank 7 used to manufacture the floor panel reinforcement member 1 further comprises patches 8 in order to locally increase the thickness and therefore the structural resistance of the part. Patches are manufactured by attaching locally on top of the initial metallic blank a further, smaller, metal blank, for example by spot welding, or by laser welding.

In a specific embodiment the floor panel reinforcement member is made by hot stamping and the blanks used to produce it comprise one of the following materials, either in the form of monolithic blanks or combined in the form of tailor welded blanks:
Steel having a composition comprising in % weight: 0.06%≤C≤0.1%, 1%≤Mn≤2%, Si≤0.5%, Al≤0.1%, 0.02%≤Cr≤0.1%, 0.02%≤Nb≤0.1%, 0.0003%≤B≤0.01%, N≤0.01%, S≤0.003%, P≤0.020% less than 0.1% of Cu, Ni and Mo, the remainder being iron and unavoidable impurities resulting from the elaboration. With this composition range, the yield strength of the corresponding area after hot stamping is comprised between 700 and 950 MPa, the tensile strength between 950 MPa and 1200 MPa and the bending angle is above 75°. For example, this material is used in the deformable portions of the floor panel reinforcement member, because its high bending angle combined with high mechanical properties allows it to absorb a high amount of crash energy, for example by bottling.
Steel having an ultimate tensile strength after hot stamping which is comprised between 1300 MPa and 1650 MPa and a yield strength which is comprised between 950 MPa and 1250 MPa.
Steel having an ultimate tensile strength after hot stamping which is comprised between 1300 MPa and 1650 MPa, a yield strength which is comprised between 950 MPa and 1250 MPa and a bending angle which is above 75°.
Steel having a composition comprising in % weight: 0.20%≤C≤0.25%, 1.1%≤Mn≤1.4%, 0.15%≤Si≤0.35%, Cr≤0.30%, 0.020%≤Ti≤0.060%, 0.020%≤Al≤0.060%, S≤0.005%, P≤0.025%, 0.002%≤B≤0.004%, the remainder being iron and unavoidable impurities resulting from the elaboration. With this composition range, the ultimate tensile strength of the corresponding area of the part after hot stamping is comprised between 1300 MPa and 1650 MPa and the yield strength is comprised between 950 MPa and 1250 MPa. For example, this steel composition is used for the non-deformable portion of the floor panel reinforcement member because it allows to resist intrusion thanks to its high mechanical properties.
Steel having a tensile strength after press-hardening higher than 1800 MPa.
Steel having a composition which comprises in % weight: 0.24%≤C≤0.38%, 0.40%≤Mn≤3%, 0.10%≤Si≤0.70%, 0.015%≤Al≤0.070%, Cr≤2%, 0.25%≤Ni≤2%, 0.015%≤Ti≤0.10%, Nb≤0.060%, 0.0005%≤B≤0.0040%, 0.003%≤N≤0.010%, S≤0,005%, P≤0,025%, %, the remainder being iron and unavoidable impurities resulting from the elaboration. With this composition range, the tensile strength of the corresponding area of the front member assembly after hot stamping is higher than 1800 MPa. For example, this material is used in the non-deformable portion.
Steel having a composition which comprises in % weight: C: 0.15-0.25%, Mn: 0.5-1.8%, Si: 0.1-1.25%, Al: 0.01-0.1%, Cr: 0.1-1.0%, Ti: 0.01-0.1%, B: 0.001-0.004%, P≤0.020%, S≤0.010%, N≤0.010% and comprising optionally one or more of the following elements, by weight percent: Mo≤0.40%, Nb≤0.08%, Ca≤0.1%, the remainder of the composition being iron and unavoidable impurities resulting from the smelting. With this composition range, the tensile strength of the corresponding area of the floor panel reinforcement member after hot stamping is higher than 1350 MPa and the bending angle is higher than 700.
Steel having a composition which comprises in % weight: C: 0.26-0.40%, Mn: 0.5-1.8%, Si: 0.1-1.25%, Al: 0.01-0.1%, Cr: 0.1-1.0%, Ti: 0.01-0.1%, B: 0.001-0.004%, P≤0.020%, S≤0.010%, N 0.010% and comprising optionally one or more of the following elements, by weight percent: Ni≤0.5%, Mo≤0.40%, Nb≤0.08%, Ca≤0.1% the remainder of the composition being iron and unavoidable impurities resulting from the smelting. With this composition range, the tensile strength of the corresponding area of the floor panel reinforcement member after hot stamping is higher than 1500 MPa and the bending angle is higher than 700.
Steel having a composition which comprises in % weight: C: 0.2-0.34%, Mn: 0.50-1.24%, Si: 0.5-2%, P≤0.020%, S≤s0.010%, N≤0.010%, and comprising optionally one or more of the following elements, by weight percent: Al: 50.2%, Cr≤0.8%, Nb≤0.06%, Ti≤0.06%, B≤0.005%, Mo≤0.35%, the remainder of the composition being iron and unavoidable impurities resulting from the smelting. With this composition range, the tensile strength of the corresponding area of the floor panel reinforcement member after hot stamping is equal to or higher than 1000 MPa and the bending angle is higher than 55°.
Steel having a composition which comprises in % weight: C: 0.13-0.4%, Mn:0.4-4.2%, Si: 0.1-2.5%, Cr≤2%, Mo≤0.65%, Nb≤0.1%, Al≤3.0%, Ti≤0.1%, B≤0.005%, P≤0.025%, S≤0.01%, N≤0.01%, Ni≤2.0%, Ca≤0.1%, W≤0.30%, V≤0.1%, Cu≤0.2%, and verifying the following combination: 114-68*C−18*Mn+20*Si−56*Cr−60*Ni−36*Al+38*Mo+79*Nb−17691*B<20, the remainder of the composition being iron and unavoidable impurities resulting from the smelting. For example, this composition is used when hot stamping the part using a multistep process.
Steel which is coated with an aluminum-based metallic coating. By aluminum based it is meant a coating that comprises at least 50% of aluminum in weight. For example, the metallic coating is an aluminum-based coating comprising 8-12% in weight of Si. For example, the metallic coating is applied by dipping the base material in a molten metallic bath. Advantageously, applying an aluminum-based metallic coating avoids the formation of surface scale during the heating step of the hot stamping process, which in turns allows to produce the parts by hot stamping without a subsequent sand blasting operation. Furthermore, the aluminum-based coating also provides corrosion protection to the part while in service on the vehicle.
Steel which is coated with an aluminum-based metallic coating comprising from 2.0 to 24.0% by weight of zinc, from 1.1 to 12.0% by weight of silicon, optionally from 0 to 8.0% by weight of magnesium, and optionally additional elements chosen from Pb, Ni, Zr, or Hf, the content by weight of each additional element being inferior to 0.3% by weight, the balance being aluminum and optionally unavoidable impurities. Advantageously, this type of metallic coating affords very good corrosion protection on the part, as well as a good surface aspect after hot stamping.

In a specific embodiment, at least the upper or lower shell is made by hot stamping a laser welded blank comprising at least one sub blank having an aluminum based metallic coating and said aluminum coated sub-blanks are prepared before-hand by ablating at least part of the metallic coating on the edges to be welded. Advantageously, this removes part of the aluminum present in the coating, which would pollute the weld seam and deteriorate its mechanical properties.

In a particular embodiment, the floor panel reinforcement member is made by hot stamping a laser welded blank comprising at least one sub blank having at least one side topped with an emissivity increasing top layer. Said emissivity increasing top layer is applied on the outermost surface of said sub-blank. Said emissivity increasing top layer allows the surface of said sub blank to have a higher emissivity compared to the same sub-blank which is not coated with said emissivity increasing top layer. Said emissivity increasing top layer can be applied either on the top or the bottom side of a sub-blank. Said emissivity increasing top layer can also be applied on both sides of said sub-blank. If said sub-blank comprises a metallic coating, such as described previously, the emissivity increasing top layer is applied on top of said metallic coating. Indeed, for the emissivity increasing top layer to increase the emissivity of the surface, it needs to cover the outermost surface of the sub-blank. Advantageously, said emissivity increasing top layer will allow to increase the heating rate of said sub-blank and therefore increase the productivity of the heating step of the hot stamping process. When using several sub blanks of differing thicknesses, said emissivity increasing top layer is advantageously applied to the sub-blanks having the highest thickness in order to decrease the difference in heating time between the different sub-blanks and therefore increase productivity, increase the hot stamping process window and overall allow to obtain a final part having homogeneous surface properties.

What is claimed is:

1-7. (canceled)

8: A floor panel reinforcement member for an automotive vehicle attached to a floor panel and comprising:
at least one front longitudinal portion;
at least one front transverse portion; and
a front transition portion,
the front longitudinal portion, front transverse portion and front transition portion each including a left and right side wall extending from the floor panel in an elevation direction up to a higher elevation than the floor panel,
the front longitudinal portion extending longitudinally from a dash panel to the front transition portion and forming with the floor panel a front longitudinal hollow volume,
the front transverse portion extending in a transverse direction between right and left side sills of the vehicle and forming with the floor panel a front transverse hollow volume and connected to the front longitudinal portion in the front transition portion,
wherein the floor panel reinforcement member is manufactured by forming a single metal blank.

9: The floor panel reinforcement member as recited in claim 8 wherein the single metal blank is a laser welded blank including several sub-blanks.

10: The floor panel reinforcement member as recited in claim 8 wherein the floor panel reinforcement member is manufactured by hot stamping the single metal blank.

11: The floor panel reinforcement member as recited in claim 8 wherein the at least one front longitudinal portion includes n distinct front longitudinal portions and at least one front transition portion includes associated front transition portions, n being an integer equal to or higher than 1,
for each front transition portion, the right and left side walls having respectively a curvature radius R1, R2, and a height H1, H2 defined as the height in the elevation direction of said transition portion right and left side walls at the point where the side wall forms an angle of 20° with the transverse direction,
wherein the product of n by the ratio of the sum of the front transition portion side wall curvature radii R1, R2 to the sum of the heights of the front transition portion side walls H1, H2 is at least equal to 4
$$n * \frac{{\sum }_{for each transition portion} ( R 1 + R 2 )}{{\sum }_{for each transition portion} ( H 1 + H 2 )} \geq 4.$$

12: The floor panel reinforcement member as recited in claim 8 further comprising at least one further transverse portion extending in a transverse direction between the side sills and having further side walls extending at least in the elevation direction such that the at least one further transverse portion forms a further transverse hollow volume with the floor panel, wherein the at least one further transverse portion is attached to the floor panel reinforcement member by lateral intermediate portions extending in a longitudinal direction between the sides of the transverse portions.

13: The floor panel reinforcement member as recited in claim 8 further comprising at least one further transverse portion extending in a transverse direction between the side sills and having further side walls extending at least in the elevation direction such that the at least one further transverse portion forms a further transverse hollow volume with the floor panel, wherein the at least one further transverse portion is attached to the floor panel reinforcement member by a central intermediate portion.

14: An automotive vehicle comprising The floor panel reinforcement member as recited in claim 8.
